(19) United States
(12) Patent Application Publication
(10) Pub. No.: US 2012/0117044 A1
(43) Pub. Date: May 10, 2012

(54) MUSIC PROVIDING SYSTEM AND APPARATUS USING MUSIC BROADCASTING AND MUSIC PROVIDING METHOD USING THE SAME

(75) Inventors: Heung In Park, Yongin (KR); Young Woo Sohn, Seoul (KR)

(73) Assignees: KIA MOTORS CORPORATION, Seoul (KR); HYUNDAI MOTOR COMPANY, Seoul (KR)

(21) Appl. No.: 13/080,094

(22) Filed: Apr. 5, 2011

(30) Foreign Application Priority Data
Nov. 9, 2010 (KR) 10-2010-0111055

(51) Int. Cl. G06F 17/30

(52) U.S. Cl. 707/706; 707/E17.102; 707/E17.108

(57) ABSTRACT

Provided is a music providing system and apparatus for use with a music broadcasting and a music providing method using the same. The music providing system includes a communication module which receives a request signal including channel information and a request signal input time point from a music providing apparatus which receives a music broadcasting from a music broadcasting station server, provides the received music broadcasting to a user, and inputs the request signal for music which is being broadcasted on a specific channel being listened to by the user. The present invention also includes a control module which transfers the request signal to a music providing server, receives a music file which is identified by the music providing server through a broadcasting schedule of the music broadcasting station server and provides the received music file to the music providing apparatus.

### CROSS-REFERENCES TO RELATED APPLICATIONS

Priority is claimed to Korean patent application number 10-2010-111055, filed on Nov. 9, 2010, the entire contents of which application is incorporated herein for all purposes by this reference.

### BACKGROUND OF THE INVENTION

1. Field of the Invention

The present invention relates to a system and an apparatus for receiving a music file to be listened to by a user in the at future time while the user listens a music broadcasting such as the radio and a music providing method using the same.

2. Description of the Related Art

Typically, when users are listening to a radio broadcasting, a digital multi-media broadcasting (DMB), or the like and they do recognize the music which is being broadcasted, there is not way for them to know what the name of the music is when the title is not broadcast by the radio station. Thus, since a user can not recognize the title of the corresponding music, it is difficult for the user to purchase the corresponding music file from the music purchasing sites accordingly.

### SUMMARY OF THE INVENTION

The present invention provides a music providing system and apparatus through which a music broadcasting and a music providing method using the same, analyzes a channel for which a request signal is generated and a request signal input time point in order to download a corresponding music file from a provider and provide the downloaded music file to a user in response to a user initiating a download request signal for downloading music which is being broadcasted. Accordingly, the music file can then be downloaded while the user is listening to the music broadcasting on the radio.

According to an aspect of the present invention, a music providing system through a music broadcasting includes a communication module and a control module. More specifically, the communication module is configured to receive a request signal, having channel information and a request signal input time point from a music providing apparatus. The music providing apparatus receives a music broadcasting from a music broadcasting station server, transfers the received music broadcasting to a user/vehicle/radio, and inputs the request signal for music which is being broadcasted in a specific channel from the user. Furthermore, the control module is configured to transfer the request signal to a music providing server, receive a request for a music file corresponding to the channel information and the request signal input time point, locates a specific song or file on the music providing server according to a broadcasting schedule of the music broadcasting station server and transfers the requested music file to the music providing apparatus, e.g., within a vehicle.

In some embodiments of the present invention, the control module on the music providing apparatus may further receive detailed information relating the music file, information of another music file related to the music file, and/or messages of other users related to the music file from the music providing server and receive a message from the user of the music file which was input into the music providing apparatus. The control module may also be configured to transfer the received message to the music providing server to request a notice for the user's message on the music providing server.

In some embodiments of the present invention, a music providing apparatus through a music broadcasting may additionally include a broadcasting reception module and a key input module. The broadcasting reception module receives a music broadcasting from a music broadcasting station server and provides the received music broadcasting to a user to be played over, e.g., a radio. The key input module inputs a request signal for music which is being broadcasted in a specific channel by a user. In this embodiment, the control module transfers the request signal including channel information and a request signal input time point to a music providing system and receives a music file corresponding to the channel information of the request signal and the request signal input time point from the music providing system.

In this exemplary embodiment, the control module may further receive detailed information relating to the music file, information relating to another music file which is related to the music file, or messages of other users related to the music file. This information is transferred from the music providing server to the control module on the music providing system. The control module may also be configured to receive messages from the user related to the music file through the key input module. The received messages are then transferred to the music providing server by the music providing system via the control module.

The music providing apparatus may further include a database in which the downloaded music files are stored and an execution module which executes the music file stored in the database.

According to another aspect of the present invention, a method of providing music using a music broadcasting system includes receiving a request signal including channel information and a request signal input time point from a music providing apparatus which is configured to receive the music broadcasting from a music broadcasting station server, provide the received music broadcasting to a user, and receive the request signal for music, which is being broadcasted in a specific channel, from the user. Subsequently, the request signal is transferred to a music providing server and a music file is received, from the music providing server, at a control module on the music providing system which corresponds to the channel information of the request signal and the request signal input time point, which are located on a broadcasting schedule of the music broadcasting station server by the music providing server. The music file is then transferred by the control module to the music providing apparatus.

More specifically, transferring a music file may also include transferring detailed information of the music file, information of another music file related to the music file, messages of other users related to the music file to the music providing apparatus. Furthermore, a message from the user related to the music file may also be received from the music providing apparatus and transferred to the music providing server.

In some embodiments of the present invention, the method of providing music using a music broadcasting may also include receiving music broadcasting on the music broadcasting apparatus, e.g., a radio, from a music broadcasting station server and transferring the received music broadcasting to a user. Subsequently, a request signal for music, which is being broadcasted in a specific channel, may be received from the user, and transferred along with the channel information and a request signal input time point to a music providing system. Once the request is received from music providing system, a music file corresponding to the channel information of the request signal and the request signal input time point, may be transferred from a music providing server to the music providing system.

The method may further include receiving detailed information relating to the music file, information of another music file related to the music file, messages of other users related to the music file which may also be transferred from the music providing server to the music providing system. The method may even further include receiving a message from the user related to the music file at a key input module and transferring the message from the user to the music providing server via the music providing system.

Accordingly, the present invention locates a music file via a music providing server using a request signal which includes channel information and a request signal input time point, which are input during receiving the music broadcasting from a music broadcasting station server by the user. Thus the music file can be downloaded and transferred to the music providing apparatus while the user is listening to that particular song on the radio. Thus, the music providing system advantageously provides the corresponding music file requested while the user listens to the music broadcasting. Ergo, when the user can not recognize the song or music that is being broadcasted, the user can initiate a request on the music providing apparatus to identify the song and download the song to the music providing apparatus accordingly. Thus, in the case where the user is interested in music while the user is listening to the specific broadcasting, but the user can not recognize a singer's name or the title of the music, it is possible for user to effectively download the interested music to the music providing apparatus while simultaneously listening to the music broadcast. Accordingly, the present invention needs to be provided with the channel information and time point information at which the user selects the interested music in order to locate and download a specific music file all while without significantly changing functions of the music providing apparatus.

In addition, because the present invention is can also receive detailed information related to the music file, information of another music file related the music file, or messages of other users related to the music file, the user may conveniently receive various kinds of information related to the corresponding music file and put up the user's opinion for the music file on the website related to the music providing server all in real time.

The methods and systems of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

The objects, features and advantages of the present invention will be more apparent from the following detailed description in conjunction with the accompanying drawings, in which:

FIG. 1 is a block diagram illustrating a configuration of an exemplary music providing network through a music broadcasting according to the present invention.

FIG. 2 is a block diagram illustrating a configuration of an exemplary music broadcasting station server according to the present invention.

FIG. 3 is a block diagram illustrating a configuration of an exemplary music providing apparatus according to the present invention.

FIG. 4 is a block diagram illustrating a configuration of an exemplary music providing system according to the present invention.

FIG. 5 is a block diagram illustrating a configuration of an exemplary music providing server according to the present invention.

FIG. 6 is a flow chart illustrating a method of providing music according to an exemplary embodiment of the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like. The present systems will be particularly useful with a wide variety of motor vehicles.

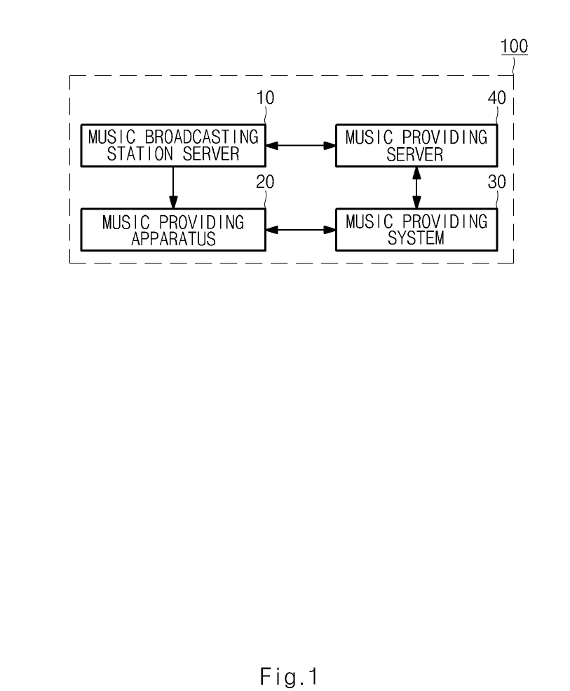

FIG. 1 is a block diagram illustrating a configuration of a music providing network 100 according to the present invention.

As shown in FIG. 1, the exemplary music providing network 100 according to the present invention includes a music broadcasting station server 10, a music providing apparatus 20, a music providing system 30, a music providing server 40, and the like.

The music broadcasting station server 10 may be embodied as either a radio broadcasting station server, a digital multi-media (DMB) broadcasting station server, a public broadcasting station server, or the like and configured to send various kinds of programs for providing music to listeners.

The music providing apparatus 20 may be embodied as a head unit of a vehicle and connected to the music providing system 30 through a communication module, for example, a Bluetooth communication module. The music providing apparatus 20 receives various kinds of music broadcastings sent from the music broadcasting station server 10 and provides the received the music broadcasting to a user via, a radio/stereo and its associated speakers. More specifically, the music providing apparatus 20 receives a request signal for music which is being broadcasted in a specific channel from the user and provides the request signal including channel information and a request signal input time point to the music providing system 30. The music providing apparatus 20 then receives a music file corresponding to the channel information of the request signal and the request signal input time point, which were transferred from the music providing server 40 to the music providing system 30, from the music providing system 30.

The music providing system 30 may be embodied as a telematics module and connected to the music providing apparatus via a communication module, for example a Bluetooth communication module. The music providing system 30 receives the request signal including the channel information and the request signal input time point from the music providing apparatus 20. The music providing system provides the received request signal to the music providing server 40. The music providing system 30 receives, from the music providing server 40, the music file corresponding to the channel information of the request signal and the request signal input time point, which are located on the music providing server 40 via a broadcasting schedule of the music broadcasting station server 10 and provides the received music file to the music providing apparatus 20.

Components of the music providing network 100 according to the present invention are described in further detail below.

—Configuration of the Music Broadcasting Station Server 10—

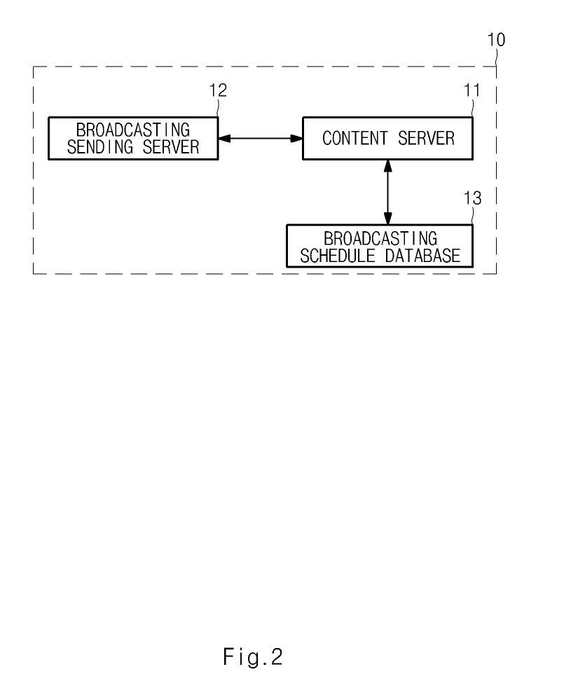

FIG. 2 is a block diagram illustrating an exemplary configuration of the music broadcasting station server 10 according to the present invention. As illustrated in FIG. 2, the music broadcasting station server 10 includes a content server 10, a broadcasting sending server 12, a broadcasting schedule database 13, and the like

The content server 11 produces contents according to a plurality of broadcasting channels. Here, the content is meant to be a general term for radio and television broadcasting programs which provide music broadcastings. The music broadcasting includes any broadcasting program which consistently provides music files or a broadcasting program including a broadcasting comment and a music file.

The broadcasting sending server 12 sends the content according to the broadcasting channel produced by the content server 11 using a frequency corresponding to the broadcasting channel.

The broadcasting schedule database 13 stores a broadcasting schedule in which identifies when a particular music file was played on or broadcast by a particular broadcasting channel. For example, information indicating that a music file B of a singer A was broadcasted from 2:25 pm to 2:29 pm, Nov. 5, 2010 and a music file D of a singer C was broadcasted from 2:42 pm to 2:48 pm, Nov. 5, 2010 on MBC radio is recorded in the broadcasting schedule accordingly.

—Configuration of the Music Providing Apparatus 20—

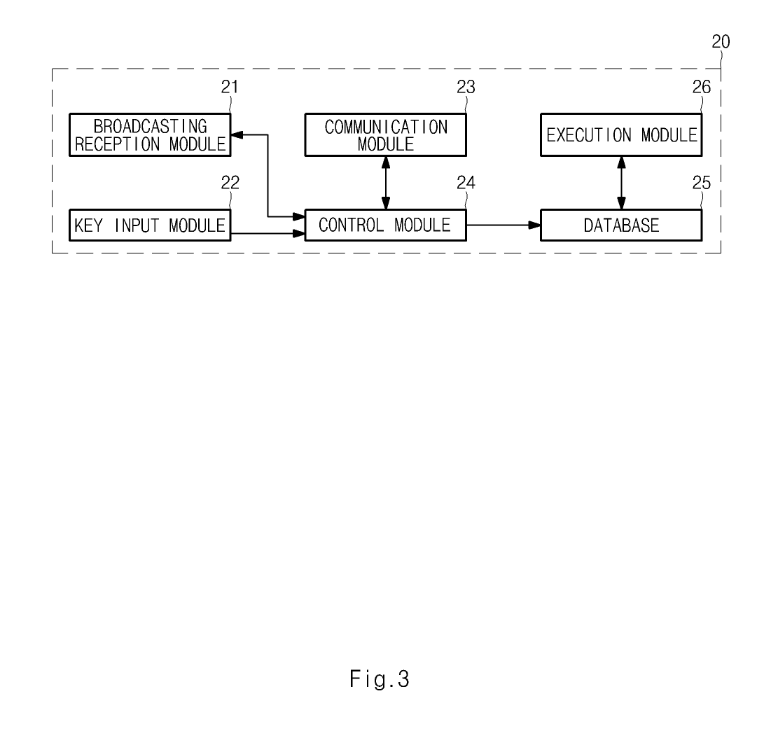

FIG. 3 is a block diagram illustrating a configuration of the music providing apparatus 20 according to the present invention.

As shown in FIG. 3, the music providing apparatus 20 includes a broadcasting reception module 21, a key input module 22, a communication module 23, a control module 24, a database 25, an execution module, and the like.

The broadcasting reception module 21 is embodied by a conventional broadcasting reception module, for example, a radio tuner, a television receiver, a DMB receiver, or the like. The broadcasting reception module 21 receives a music broadcasting from the music broadcasting station server 10 and provides the received music broadcasting to the user.

The key input module 22 inputs a request signal for music which is being broadcast on a specific channel being listened to by the user. For example, when a user listens to music B of a signer A on MBC radio channel at about 2:25 pm, Nov. 5 2010, and is not able to recognize the singer's name and/or the title of the music, the user may input a request signal for downloading the music which is being broadcasting presently through the key input module 22. Alternatively, the key input module 22 may receive a message related to the music file from the user.

The communication module 23 may be embodied by a near filed communication (NFC) module such as a Bluetooth module. The communication module 23 is configured by utilizing a pairing relationship with the music providing system 30 and data communicates with the music providing system 30.

The control module 24 locates the channel information of the request signal and the request signal input time point based on the point in time when the request signal was transferred through the key input module 22 and a channel of the communication reception module 21. The control module 24 provides the request signal including the channel information and the request signal input time point to the music providing system 30. The control module 24 will then receive a music file corresponding to the channel information of the request signal and the request signal input time point, which are transferred from the music providing server 40 to the music providing server 30, from the music providing system 30.

Additionally, the control module 24 may also receive detailed information relating to the music file, information of another music file related to the music file, or messages from other users relating to the music file, from the music providing system 30. The control module 24 receives a message related to the music file from the user through the key input module 22 and provides the received message to the music providing server 40 through the music providing system 30.

The database 25 stores the music file and the message transferred from the music providing system 30 and the execution module 26 executes the music file and the message stored in the database 25 accordingly.

—Configuration of the Music Providing System 30—

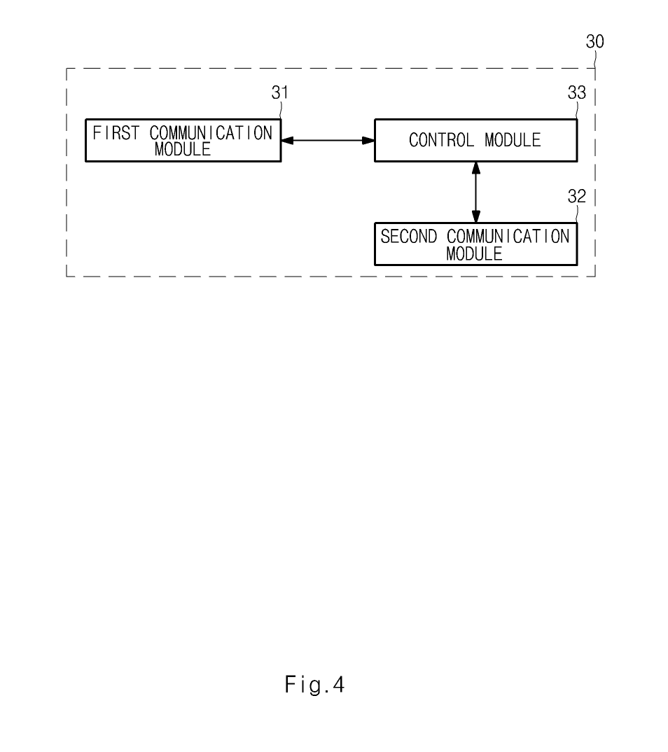

FIG. 4 is a block diagram illustrating an exemplary configuration of the music providing system 30 according to the present invention

As shown in FIG. 4, the music providing system 30 includes a first communication module 31, a second communication module 32, a control module 33, and the like.

The first communication module 31 may be embodied by a NFC module such as a Bluetooth module. The first communication module 31 is configured utilizing a pairing relationship with the music providing apparatus 20 and data communicates with the music providing apparatus 20.

The second communication module 32 may be embodied by a wireless telecommunication module such as a code division multiple access (CDMA) communication module and data communicates with the music providing server 40.

In this embodiment of the present invention, the control module 33 receives a music broadcasting from the music broadcasting station server 10 using the first communication module 31 and provides the received music broadcasting to the user. The control module 33 then receives the request signal including the channel information and the request signal input time point from the music providing apparatus 20 which inputs the request signal for the music which is being broadcasted in the specific channel from the user. The control module 33 then provides the request signal to the music providing server 40 using the second communication module 32 and receives the music file corresponding to the channel information of the request signal and the request signal input time point, which are grasped/identified or located by the music providing server 40 through the broadcasting schedule of the music broadcasting station server 10, from the music providing server 40. The control module 33 then provides the music file to the music providing apparatus 20.

Additionally, the control module 33 may receive detailed information of the music file, information of another music file related the music file, or messages from other users related to the music file from the music providing server 40 through the second communication module 32 and provide the information and the messages to the music providing system 20 using the first communication module 31. The control module 33 then receives a message related to the music file from the music providing apparatus 20 and transfers the received message to the music providing server 40 to request a notice for the message on the music providing server 40.

—Configuration of Music Providing Server 40—

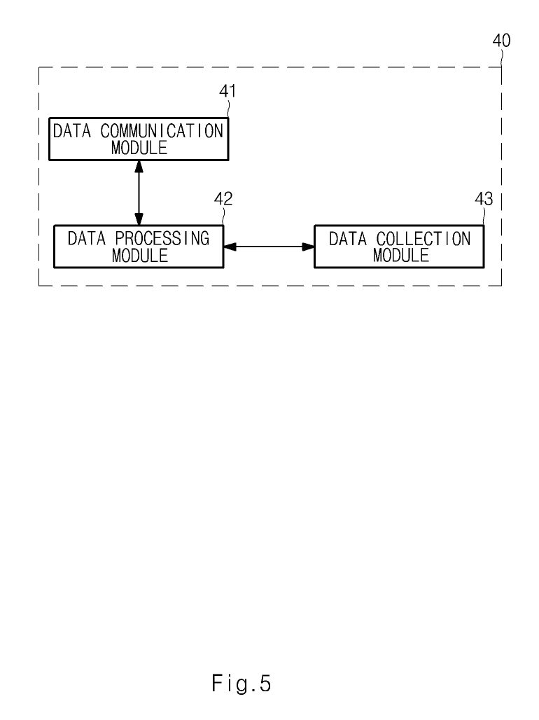

FIG. 5 is a block diagram illustrating an exemplary configuration of the music providing server 40 according to the present invention.

As shown in FIG. 5, the music providing server 40 includes a data communication module 41, a data processing module 42, a data collection module 43, and the like.

The data communication module 41 data communicates with the music providing system 30 and the music broadcasting station server 10. The data communication module 41 receives request signals that include the channel information and the request signal input time point from the music providing system 30 and also a broadcasting schedule for various channels from the music broadcasting station server 10.

The data processing module 42 identifies the music file that corresponds to the request signal by using the broadcasting schedule and extracts the identified music file from a separate music file database 25. For example, when the channel information of the request signal is MBC radio channel, the request signal input time point is 2:25 pm, on Nov. 5, 2010 and the music which was broadcasted at 2:25 pm, Nov. 5, 2010 in the broadcasting schedule of the MBC radio channel is music B of a singer A, the data processing module 42 extracts the music file B of the singer A from the music file database 25. The data processing module 42 then provides to the music providing apparatus 20 through the music providing system 30, the extracted music file to the music providing system 30. Additionally, the data processing module 42 may also provide detailed information relating to the music file, information of another music file related to the music file, or messages from other users related to the music file which is collected by the data collection module 43 (described later). The data processing module 42 also receives user messages related to the music file from the music providing apparatus 20 through the music providing system 30 to be posted on a website related to the music providing server 40.

More specifically, the data collection module 43 collects the detailed information related to the music file, the information of the other music file related to the music file, and/or the messages of the other users related to the music file from a website related to the music providing server 40 and provides the collected information and the messages to the data processing module 42. Illustratively, the detailed information of the music file may include music information, evaluation information, purchasing information, and/or the like.

Alternatively, other music files related to the music file may include a genre and title similar to the music file B of the singer A, another music file of the singer A, and/or another music file of a singer C publicly affected by or related to the singer A. The messages of the other users related to the music file may also denote messages of other users related to the music file published on the website related to the music providing server 40.

A music providing method according to the present invention is described below.

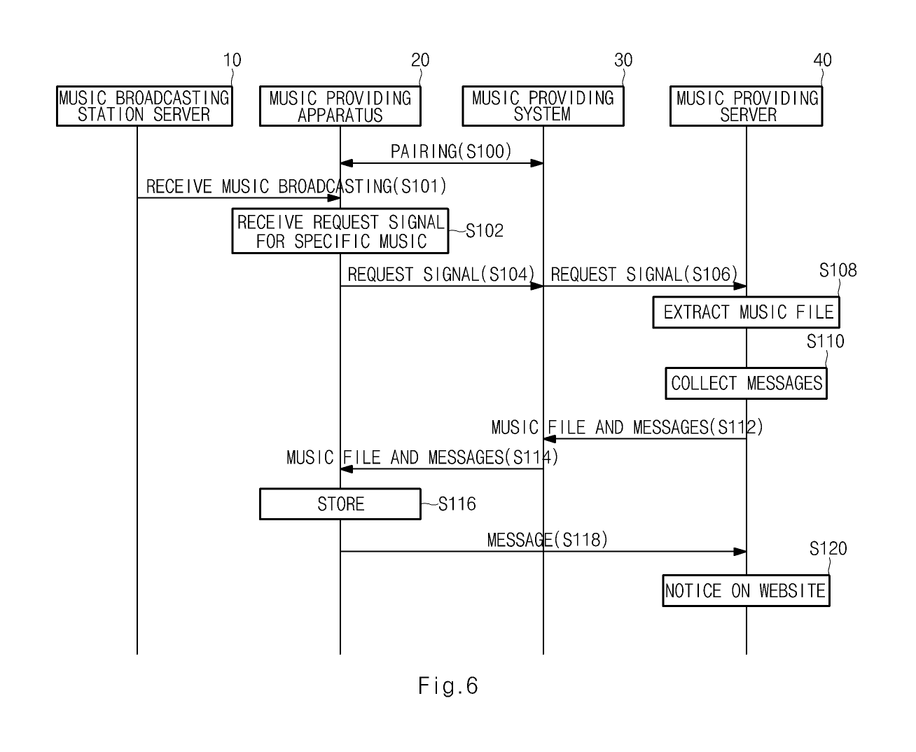

FIG. 6 is a flowchart illustrating a sequence of a music providing method according to the present invention. First, the music providing apparatus 20 and the music providing system 30 are paired to create a pairing relationship (S100).

Next, the broadcasting reception module 21 of the music providing apparatus 20 receives a music broadcasting of a specific channel from the music broadcasting station server 10 and provides the received music broadcasting to a user (S101).

The key input module 22 of the music providing apparatus 20 may input a request signal for the music which is being broadcasted on the specific channel (S102).

The control module 24 of the music providing system 20 then provides the request signal including channel information and a request signal input time point to the music providing system 30 (S104) and provides the request signal to the music providing server 40 (S106).

The data processing module 42 of the music providing server 40 the identifies the music file corresponding to the request signal using the broadcasting schedule and extracts the identified music file from a separate music file database 25 (S108).

The data collection module 43 on the music providing server 40 may then collects detailed information relating to the music file, information of another music file related to the music file, or messages of other users related to the music file (S110).

Next, the data processing module 42 of the music providing server 40 provides the music file, the detailed information of the music file, the information of the other music file related to the music file, or the messages of the other users related to the music file to the music providing system 30 (S112).

The control module 33 of the music providing system 30 then provides the music file, the detailed information of the music file, the information of the other music file related to the music file, or the messages of the other users related to the music file to the music providing apparatus 20 (S114).

Next, the control module 24 of the music providing apparatus 20 stores the music file, the detailed information of the music file, the information of the other music file related to the music file, or the messages of the other users related to the music file to the database 25 on the music providing apparatus(S116).

The control module 24 of the music providing apparatus 20 may also receive messages related to the music file from the user using the key input module 22 and provide the messages to the music providing server 40 through the music providing system 30 (S118).

The data processing module 42 of the music providing server 40 may then publish or post the message of the user related to the music file on a website related to the music providing server 40 (S120).

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A music providing system through a music broadcasting, the system comprising:
a communication module which receives a request signal including channel information and a request signal input time point from a music providing apparatus which receives a music broadcasting from a music broadcasting station server, provides the received music broadcasting to a user, and inputs the request signal for music which is being broadcasted in a specific channel from the user; and
a control module which transfers the request signal to a music providing server, receives a music file corresponding to the channel information and the request signal input time point, which are grasped by the music providing server through a broadcasting schedule of the music broadcasting station server, from the music providing server and provides the received music file to the music providing apparatus.

2. The system according to claim 1, wherein the control module further receives detailed information of the music file, information of another music file related to the music file, or messages of other users related to the music file from the music providing server to transfer the received information and messages to the music providing apparatus and receives a message of the user related to the music file from the music providing apparatus and transfers the received message to the music providing server to request a notice for the user's message on the music providing server.

3. A music providing apparatus through a music broadcasting, the apparatus comprising:
a broadcasting reception module which receives a music broadcasting from a music broadcasting station server and provides the received music broadcasting to a user;
a key input module which inputs a request signal for music which is being broadcasted in a specific channel by a user; and
a control module which transfers the request signal including channel information and a request signal input time point to a music providing system,
wherein the control module receives a music file corresponding to the channel information of the request signal and the request signal input time point, which is received from a music providing server to the music providing system, from the music providing system.

4. The apparatus according to claim 3, wherein the control module further receives detailed information of the music file, information of another music file related to the music file, or messages of other users related to the music file, which is transferred from the music providing server to the music providing system, from the music providing system and receives a message of the user related to the music file from the user through the key input module to transfer the received information and messages to the music providing server through the music providing system.

5. The apparatus according to claim 3, further comprising:
a database in which the music file is stored; and
an execution module which executes the music file stored in the database.

6. A method of providing music using a music broadcasting, a method comprising:
(a) receiving a request signal including channel information and a request signal input time point from a music providing apparatus which receives the music broadcasting from a music broadcasting station server, provides the received music broadcasting to a user, and receives the request signal for music, which is being broadcasted in a specific channel, from the user;
(b) transferring the request signal to a music providing server and receiving a music file corresponding to the channel information of the request signal and the request signal input time point, which is are grasped through a broadcasting schedule of the music broadcasting station server by the music providing server, from the music providing server; and
(c) transferring the music file to the music providing apparatus.

7. The method according to claim 6, wherein the (c) transferring a music file includes:
(c-1) further receiving detailed information of the music file, information of another music file related to the music file, messages of other users related to the music file and transferring the information and the messages to the music providing apparatus; and
(c-2) receives a message of the user related to the music file from the music providing apparatus and transferring the message of the user to the music providing server to request a notice for the message of the user on the music providing server.

8. A method of providing music using a music broadcasting, the method comprising:
(a) receiving the music broadcasting from a music broadcasting station server and transferring the received music broadcasting to a user;
(b) receiving a request signal for music, which is being broadcasted in a specific channel, from a user;
(c) transferring the request signal including channel information and a request signal input time point to a music providing system; and
(d) receiving a music file corresponding to the channel information of the request signal and the request signal input time point, which are transferred from a music providing server to the music providing system, from the music providing system.

9. The method according to claim 8, further comprising:
(e) further receiving detailed information of the music file, information of another music file related to the music file, a messages of other users related to the music file, which is transferred from the music providing server to the music providing system, from the music providing system; and
(f) receiving a message of the user related to the music file from the user using a key input module and transferring the message of the user to the music providing server through the music providing system.

10. A system for providing music broadcasted by a music providing broadcaster, the system comprising:
a communication module configured to receive a request including channel information and an input time from a music providing apparatus, wherein the music providing apparatus receives information from a first server, provides the received information to a user, and inputs the request signal for music which is being broadcasted on a specific channel to the user; and
a control module configured to transfer the request signal to a second server, receive, from the music providing server, a music file corresponding to the channel information and the request signal input time point, which was identified by the second server via a schedule received from the first server, and provide the received music file to the music providing apparatus.
